(19) United States
(12) Patent Application Publication
(10) Pub. No.: US 2025/0185002 A1
(43) Pub. Date: Jun. 5, 2025

(54) HANDLING OVERLAPPING UPLINK TRANSMISSIONS ACROSS DIFFERENT TIMING ADVANCE GROUPS

(71) Applicant: QUALCOMM Incorporated, San Diego, CA (US)

(72) Inventors: Shaozhen GUO, Beijing (CN); Mostafa KHOSHNEVISAN, San Diego, CA (US); Jing SUN, San Diego, CA (US); Xiaoxia ZHANG, San Diego, CA (US); Fang YUAN, Beijing (CN); Yan ZHOU, San Diego, CA (US); Tao LUO, San Diego, CA (US)

(21) Appl. No.: 18/845,235

(22) PCT Filed: Apr. 29, 2022
(86) PCT No.: PCT/CN2022/090447

§ 371 Date: Sep. 9, 2024

(51) Int. Cl. H04W 72/1268; H04W 56/00

(52) U.S. Cl. CPC H04W 72/1268; H04W 56/0045

(57) ABSTRACT

Certain aspects of the present disclosure provide techniques for wireless communication by a user equipment (UE), generally including detecting that the UE is scheduled to transmit a first uplink (UL) transmission associated with a first timing advance group (TAG) that at least potentially overlaps with a second uplink transmission associated with a second TAG, selecting, based on one or more conditions, one of the first or second UL transmissions to transmit, and transmitting the selected UL transmission.

### BACKGROUND

### Field of the Disclosure

Aspects of the present disclosure relate to wireless communications, and more particularly, to techniques for handling overlapping uplink (UL) channels and signals across different timing advance groups (TAGs).

### Description of Related Art

Wireless communications systems are widely deployed to provide various telecommunication services such as telephony, video, data, messaging, broadcasts, or other similar types of services. These wireless communications systems may employ multiple-access technologies capable of supporting communications with multiple users by sharing available wireless communications system resources with those users

Although wireless communications systems have made great technological advancements over many years, challenges still exist. For example, complex and dynamic environments can still attenuate or block signals between wireless transmitters and wireless receivers. Accordingly, there is a continuous desire to improve the technical performance of wireless communications systems, including, for example: improving speed and data carrying capacity of communications, improving efficiency of the use of shared communications mediums, reducing power used by transmitters and receivers while performing communications, improving reliability of wireless communications, avoiding redundant transmissions and/or receptions and related processing, improving the coverage area of wireless communications, increasing the number and types of devices that can access wireless communications systems, increasing the ability for different types of devices to intercommunicate, increasing the number and type of wireless communications mediums available for use, and the like. Consequently, there exists a need for further improvements in wireless communications systems to overcome the aforementioned technical challenges and others.

### SUMMARY

One aspect provides a method for wireless communication by a user equipment (UE). The method includes detecting that the UE is scheduled to transmit a first uplink (UL) transmission associated with a first timing advance group (TAG) that at least potentially overlaps with a second uplink transmission associated with a second TAG. The method includes selecting, based on one or more conditions, one of the first or second UL transmissions to transmit. The method includes transmitting the selected UL transmission.

Other aspects provide: an apparatus operable, configured, or otherwise adapted to perform any one or more of the aforementioned methods and/or those described elsewhere herein; a non-transitory, computer-readable media comprising instructions that, when executed by a processor of an apparatus, cause the apparatus to perform the aforementioned methods as well as those described elsewhere herein; a computer program product embodied on a computer-readable storage medium comprising code for performing the aforementioned methods as well as those described elsewhere herein; and/or an apparatus comprising means for performing the aforementioned methods as well as those described elsewhere herein. By way of example, an apparatus may comprise a processing system, a device with a processing system, or processing systems cooperating over one or more networks.

The following description and the appended figures set forth certain features for purposes of illustration.

### BRIEF DESCRIPTION OF DRAWINGS

The appended figures depict certain features of the various aspects described herein and are not to be considered limiting of the scope of this disclosure.

FIG. 1 depicts an example wireless communications network.

FIG. 2 depicts an example disaggregated base station architecture.

FIG. 3 depicts aspects of an example base station and an example user equipment.

FIGS. 4A, 4B, 4C, and 4D depict various example aspects of data structures for a wireless communications network.

FIG. 5 depicts an example multiple transmission reception point (TRP) deployment.

FIG. 6 depicts example control resource set (COREST) identifiers (IDs) associated with a CORESET pool index value.

FIG. 7A, FIG. 7B and FIG. 7C depict timing advance values for a first and second TRP in a multi-TRP network.

FIG. 8A and FIG. 8B depict example timing advance group (TAG) IDs for multi-TRP networks.

FIG. 9A and FIG. 9B depict first and second uplink (UL) transmissions that are overlapping and non-overlapping, based on multiple timing advances (TAs).

FIG. 10 depicts an example call flow diagram for communications in a network between a user equipment (UE) and a network entity, in accordance with aspects of the present disclosure.

FIG. 11A and FIG. 11B depict first and second sounding reference signals (SRS) that overlap based on multiple TAs.

FIG. 12A and FIG. 12B depict a physical uplink control channel (PUCCH) and a SRS overlapping based on multiple TAs, that may be handled in accordance with aspects of the present disclosure.

FIG. 13A and FIG. 13B depict a physical uplink shared channel (PUSCH) and a SRS overlapping based on multiple TAs, that may be handled in accordance with aspects of the present disclosure.

FIG. 14A and FIG. 14B depict a physical random access channel (PRACH) and an UL transmission overlapping based on multiple TAs, that may be handled in accordance with aspects of the present disclosure.

FIG. 15A and FIG. 15B depict a PUCCH and a PUSCH overlapping based on multiple TAs, that may be handled in accordance with aspects of the present disclosure.

FIG. 16A and FIG. 16B depict a first and second UL transmissions having a potential overlap less than a threshold, that may be handled in accordance with aspects of the present disclosure.

FIG. 17 depicts a method for wireless communications.

FIG. 18 depicts aspects of an example communications device.

### DETAILED DESCRIPTION

Aspects of the present disclosure provide apparatuses, methods, processing systems, and computer-readable mediums for handling overlapping uplink (UL) channels and signals across different timing advance groups (TAGs).

In current wireless systems, a user equipment (UE) may be scheduled to transmit signaling to more than one transmit reception points (TRP) within a given time. In some cases, the UE may be configured with a timing advance (TA) for each scheduled transmission. The TA determines when the UE sends an uplink transmission and allows the UE to adjust the timing of an UL transmission in order to align the UL transmission with future transmissions in time domain. In other words, the TA values are designed to ensure the uplink transmissions arrive at the TRP aligned with a boundary of a time slot.

In a multiple TRP (mTRP) scenario, a UE may be located different distances from different TRPs, which may result in uplink transmissions taking different amounts of time to reach the different TRPs. Because of this, when a UE is scheduled to transmit UL signaling to multiple TRPs, the UE may apply different TA values to adjust the UL transmissions sent to the different TRPs. Each TA value may be associated with a different TA group (TAG) to which a corresponding TRP belongs. TRPs that belong to the same TAG share common TA values.

One potential issue is that when a sends UL transmissions to different TRPs belonging to different TAGs, the UL transmissions may overlap in time. In some cases, a UE may be unable to transmit overlapping UL transmissions simultaneously and may drop one of the overlapping UL transmissions. Unfortunately, this may result in undue delay and power consumption that may be prompted by transmit failure and subsequent retransmission.

Aspects of the present disclosure describe techniques for handling overlapping UL transmission across different TA groups. In one example, a UE may determine which UL transmission to select for transmission based on a prioritization scheme. A UE may transmit the selected UL transmission while dropping the non-selected. A UE may also transmit the selected UL transmission and some portions of the non-selected UL transmission, while dropping only symbols of the non-selected UL transmission that overlap with symbols of the selected UL transmission.

Accordingly, aspects of the present disclosure may help avoid resource waste and latency associated with transmission failure that may occur if it is unable to drop either UL transmission.

### Introduction to Wireless Communications Networks

The techniques and methods described herein may be used for various wireless communications networks. While aspects may be described herein using terminology commonly associated with 3G, 4G, and/or 5G wireless technologies, aspects of the present disclosure may likewise be applicable to other communications systems and standards not explicitly mentioned herein.

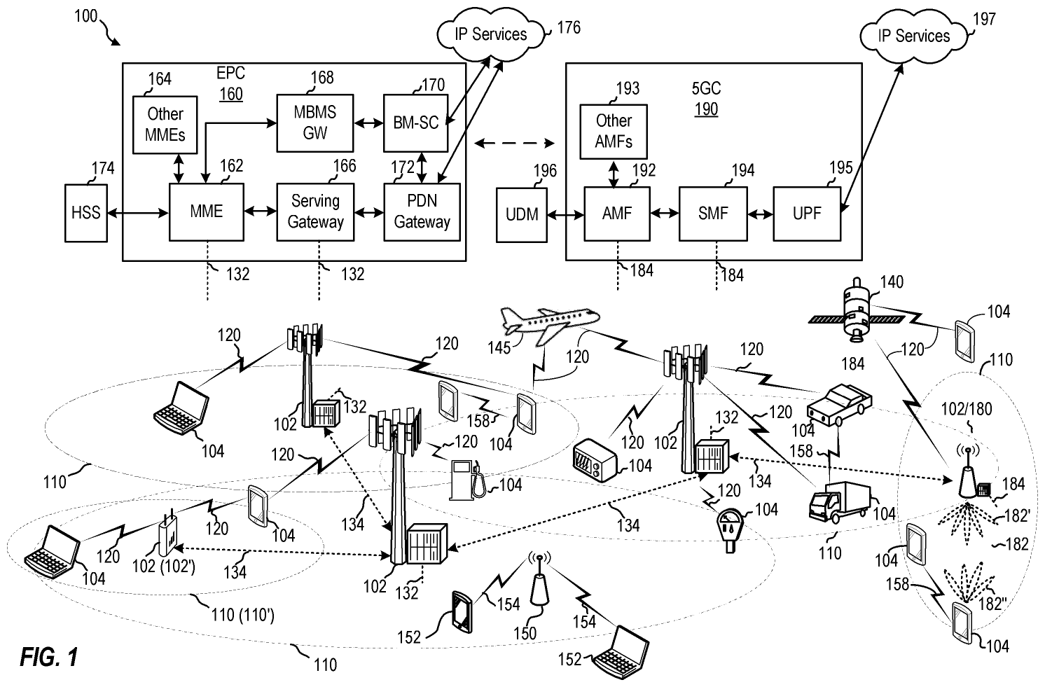

FIG. 1 depicts an example of a wireless communications network 100, in which aspects described herein may be implemented.

Generally, wireless communications network 100 includes various network entities (alternatively, network elements or network nodes). A network entity is generally a communications device and/or a communications function performed by a communications device (e.g., a user equipment (UE), a base station (BS), a component of a BS, a server, etc.). For example, various functions of a network as well as various devices associated with and interacting with a network may be considered network entities. Further, wireless communications network 100 includes terrestrial aspects, such as ground-based network entities (e.g., BSs 102), and non-terrestrial aspects, such as satellite 140 and aircraft 145, which may include network entities on-board (e.g., one or more BSs) capable of communicating with other network elements (e.g., terrestrial BSs) and user equipments.

In the depicted example, wireless communications network 100 includes BSs 102, UEs 104, and one or more core networks, such as an Evolved Packet Core (EPC) 160 and 5G Core (5GC) network 190, which interoperate to provide communications services over various communications links, including wired and wireless links.

FIG. 1 depicts various example UEs 104, which may more generally include: a cellular phone, smart phone, session initiation protocol (SIP) phone, laptop, personal digital assistant (PDA), satellite radio, global positioning system, multimedia device, video device, digital audio player, camera, game console, tablet, smart device, wearable device, vehicle, electric meter, gas pump, large or small kitchen appliance, healthcare device, implant, sensor/actuator, display, internet of things (IoT) devices, always on (AON) devices, edge processing devices, or other similar devices. UEs 104 may also be referred to more generally as a mobile device, a wireless device, a wireless communications device, a station, a mobile station, a subscriber station, a mobile subscriber station, a mobile unit, a subscriber unit, a wireless unit, a remote unit, a remote device, an access terminal, a mobile terminal, a wireless terminal, a remote terminal, a handset, and others.

BSs 102 wirelessly communicate with (e.g., transmit signals to or receive signals from) UEs 104 via communications links 120. The communications links 120 between BSs 102 and UEs 104 may include uplink (UL) (also referred to as reverse link) transmissions from a UE 104 to a BS 102 and/or downlink (DL) (also referred to as forward link) transmissions from a BS 102 to a UE 104. The communications links 120 may use multiple-input and multiple-output (MIMO) antenna technology, including spatial multiplexing, beamforming, and/or transmit diversity in various aspects.

BSs 102 may generally include: a NodeB, enhanced NodeB (eNB), next generation enhanced NodeB (ng-eNB), next generation NodeB (gNB or gNodeB), access point, base transceiver station, radio base station, radio transceiver, transceiver function, transmission reception point, and/or others. Each of BSs 102 may provide communications coverage for a respective geographic coverage area 110, which may sometimes be referred to as a cell, and which may overlap in some cases (e.g., small cell 102′ may have a coverage area 110′ that overlaps the coverage area 110 of a macro cell). A BS may, for example, provide communications coverage for a macro cell (covering relatively large geographic area), a pico cell (covering relatively smaller geographic area, such as a sports stadium), a femto cell (relatively smaller geographic area (e.g., a home)), and/or other types of cells.

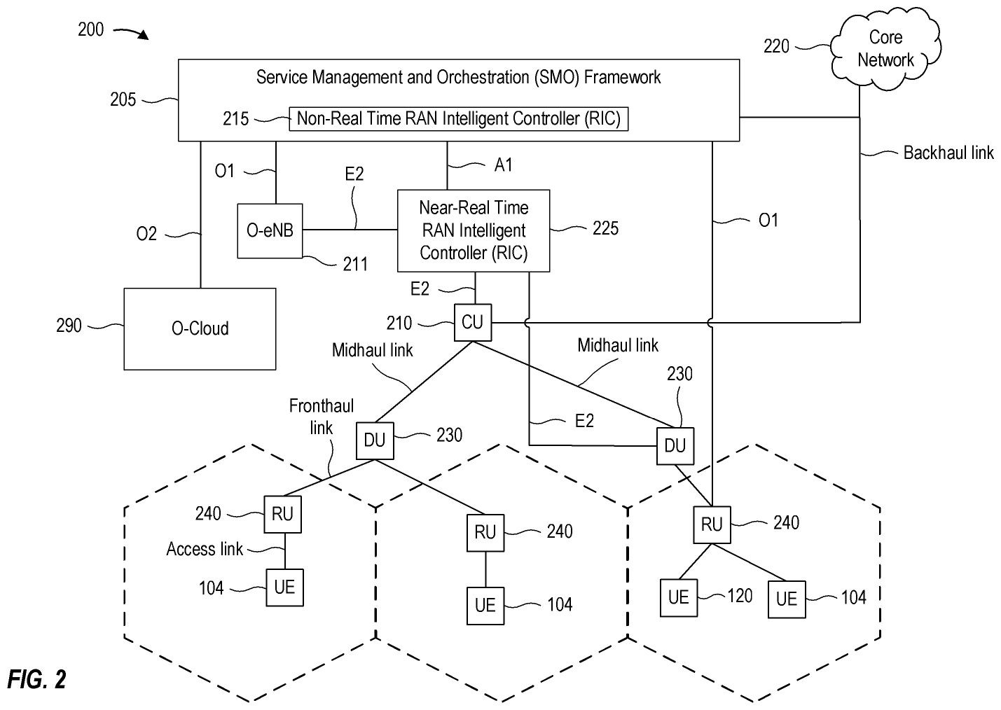

While BSs 102 are depicted in various aspects as unitary communications devices, BSs 102 may be implemented in various configurations. For example, one or more components of a base station may be disaggregated, including a central unit (CU), one or more distributed units (DUs), one or more radio units (RUs), a Near-Real Time (Near-RT) RAN Intelligent Controller (RIC), or a Non-Real Time (Non-RT) RIC, to name a few examples. In another example, various aspects of a base station may be virtualized. More generally, a base station (e.g., BS 102) may include components that are located at a single physical location or components located at various physical locations. In examples in which a base station includes components that are located at various physical locations, the various components may each perform functions such that, collectively, the various components achieve functionality that is similar to a base station that is located at a single physical location. In some aspects, a base station including components that are located at various physical locations may be referred to as a disaggregated radio access network architecture, such as an Open RAN (O-RAN) or Virtualized RAN (VRAN) architecture. FIG. 2 depicts and describes an example disaggregated base station architecture.

Different BSs 102 within wireless communications network 100 may also be configured to support different radio access technologies, such as 3G, 4G, and/or 5G. For example, BSs 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., an S1 interface). BSs 102 configured for 5G (e.g., 5G NR or Next Generation RAN (NG-RAN)) may interface with 5GC 190 through second backhaul links 184. BSs 102 may communicate directly or indirectly (e.g., through the EPC 160 or 5GC 190) with each other over third backhaul links 134 (e.g., X2 interface), which may be wired or wireless.

Wireless communications network 100 may subdivide the electromagnetic spectrum into various classes, bands, channels, or other features. In some aspects, the subdivision is provided based on wavelength and frequency, where frequency may also be referred to as a carrier, a subcarrier, a frequency channel, a tone, or a subband. For example, 3GPP currently defines Frequency Range 1 (FR1) as including 410 MHz-7125 MHz, which is often referred to (interchangeably) as “Sub-6 GHz”. Similarly, 3GPP currently defines Frequency Range 2 (FR2) as including 24,250 MHz-52,600 MHz, which is sometimes referred to (interchangeably) as a “millimeter wave” (“mmW” or “mmWave”). A base station configured to communicate using mm Wave/near mmWave radio frequency bands (e.g., a mmWave base station such as BS 180) may utilize beamforming (e.g., 182) with a UE (e.g., 104) to improve path loss and range.

The communications links 120 between BSs 102 and, for example, UEs 104, may be through one or more carriers, which may have different bandwidths (e.g., 5, 10, 15, 20, 100, 400, and/or other MHz), and which may be aggregated in various aspects. Carriers may or may not be adjacent to each other. Allocation of carriers may be asymmetric with respect to DL and UL (e.g., more or fewer carriers may be allocated for DL than for UL).

Communications using higher frequency bands may have higher path loss and a shorter range compared to lower frequency communications. Accordingly, certain base stations (e.g., 180 in FIG. 1) may utilize beamforming 182 with a UE 104 to improve path loss and range. For example, BS 180 and the UE 104 may each include a plurality of antennas, such as antenna elements, antenna panels, and/or antenna arrays to facilitate the beamforming. In some cases, BS 180 may transmit a beamformed signal to UE 104 in one or more transmit directions 182′. UE 104 may receive the beamformed signal from the BS 180 in one or more receive directions 182″. UE 104 may also transmit a beamformed signal to the BS 180 in one or more transmit directions 182″. BS 180 may also receive the beamformed signal from UE 104 in one or more receive directions 182′. BS 180 and UE 104 may then perform beam training to determine the best receive and transmit directions for each of BS 180 and UE 104. Notably, the transmit and receive directions for BS 180 may or may not be the same. Similarly, the transmit and receive directions for UE 104 may or may not be the same.

Wireless communications network 100 further includes a Wi-Fi AP 150 in communication with Wi-Fi stations (STAs) 152 via communications links 154 in, for example, a 2.4 GHz and/or 5 GHz unlicensed frequency spectrum.

Certain UEs 104 may communicate with each other using device-to-device (D2D) communications link 158. D2D communications link 158 may use one or more sidelink channels, such as a physical sidelink broadcast channel (PSBCH), a physical sidelink discovery channel (PSDCH), a physical sidelink shared channel (PSSCH), a physical sidelink control channel (PSCCH), and/or a physical sidelink feedback channel (PSFCH).

EPC 160 may include various functional components, including: a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and/or a Packet Data Network (PDN) Gateway 172, such as in the depicted example. MME 162 may be in communication with a Home Subscriber Server (HSS) 174. MME 162 is the control node that processes the signaling between the UEs 104 and the EPC 160. Generally, MME 162 provides bearer and connection management.

Generally, user Internet protocol (IP) packets are transferred through Serving Gateway 166, which itself is connected to PDN Gateway 172. PDN Gateway 172 provides UE IP address allocation as well as other functions. PDN Gateway 172 and the BM-SC 170 are connected to IP Services 176, which may include, for example, the Internet, an intranet, an IP Multimedia Subsystem (IMS), a Packet Switched (PS) streaming service, and/or other IP services.

BM-SC 170 may provide functions for MBMS user service provisioning and delivery. BM-SC 170 may serve as an entry point for content provider MBMS transmission, may be used to authorize and initiate MBMS Bearer Services within a public land mobile network (PLMN), and/or may be used to schedule MBMS transmissions. MBMS Gateway 168 may be used to distribute MBMS traffic to the BSs 102 belonging to a Multicast Broadcast Single Frequency Network (MBSFN) area broadcasting a particular service, and/or may be responsible for session management (start/stop) and for collecting eMBMS related charging information.

5GC 190 may include various functional components, including: an Access and Mobility Management Function (AMF) 192, other AMFs 193, a Session Management Function (SMF) 194, and a User Plane Function (UPF) 195. AMF 192 may be in communication with Unified Data Management (UDM) 196.

AMF 192 is a control node that processes signaling between UEs 104 and 5GC 190. AMF 192 provides, for example, quality of service (QoS) flow and session management.

Internet protocol (IP) packets are transferred through UPF 195, which is connected to the IP Services 197, and which provides UE IP address allocation as well as other functions for 5GC 190. IP Services 197 may include, for example, the Internet, an intranet, an IMS, a PS streaming service, and/or other IP services.

In various aspects, a network entity or network node can be implemented as an aggregated base station, as a disaggregated base station, a component of a base station, an integrated access and backhaul (IAB) node, a relay node, a sidelink node, to name a few examples.

FIG. 2 depicts an example disaggregated base station 200 architecture. The disaggregated base station 200 architecture may include one or more central units (CUs) 210 that can communicate directly with a core network 220 via a backhaul link, or indirectly with the core network 220 through one or more disaggregated base station units (such as a Near-Real Time (Near-RT) RAN Intelligent Controller (RIC) 225 via an E2 link, or a Non-Real Time (Non-RT) RIC 215 associated with a Service Management and Orchestration (SMO) Framework 205, or both). A CU 210 may communicate with one or more distributed units (DUs) 230 via respective midhaul links, such as an F1 interface. The DUs 230 may communicate with one or more radio units (RUS) 240 via respective fronthaul links. The RUs 240 may communicate with respective UEs 104 via one or more radio frequency (RF) access links. In some implementations, the UE 104 may be simultaneously served by multiple RUs 240.

Each of the units, e.g., the CUS 210, the DUs 230, the RUs 240, as well as the Near-RT RICs 225, the Non-RT RICs 215 and the SMO Framework 205, may include one or more interfaces or be coupled to one or more interfaces configured to receive or transmit signals, data, or information (collectively, signals) via a wired or wireless transmission medium. Each of the units, or an associated processor or controller providing instructions to the communications interfaces of the units, can be configured to communicate with one or more of the other units via the transmission medium. For example, the units can include a wired interface configured to receive or transmit signals over a wired transmission medium to one or more of the other units. Additionally or alternatively, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 210 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 210. The CU 210 may be configured to handle user plane functionality (e.g., Central Unit-User Plane (CU-UP)), control plane functionality (e.g., Central Unit-Control Plane (CU-CP)), or a combination thereof. In some implementations, the CU 210 can be logically split into one or more CU-UP units and one or more CU-CP units. The CU-UP unit can communicate bidirectionally with the CU-CP unit via an interface, such as the El interface when implemented in an O-RAN configuration. The CU 210 can be implemented to communicate with the DU 230, as necessary, for network control and signaling.

The DU 230 may correspond to a logical unit that includes one or more base station functions to control the operation of one or more RUs 240. In some aspects, the DU 230 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3rd Generation Partnership Project (3GPP). In some aspects, the DU 230 may further host one or more low PHY layers. Each layer (or module) can be implemented with an interface configured to communicate signals with other layers (and modules) hosted by the DU 230, or with the control functions hosted by the CU 210.

Lower-layer functionality can be implemented by one or more RUs 240. In some deployments, an RU 240, controlled by a DU 230, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 240 can be implemented to handle over the air (OTA) communications with one or more UEs 104. In some implementations, real-time and non-real-time aspects of control and user plane communications with the RU(s) 240 can be controlled by the corresponding DU 230. In some scenarios, this configuration can enable the DU(s) 230 and the CU 210 to be implemented in a cloud-based RAN architecture, such as a vRAN architecture.

The SMO Framework 205 may be configured to support RAN deployment and provisioning of non-virtualized and virtualized network elements. For non-virtualized network elements, the SMO Framework 205 may be configured to support the deployment of dedicated physical resources for RAN coverage requirements which may be managed via an operations and maintenance interface (such as an O1 interface). For virtualized network elements, the SMO Framework 205 may be configured to interact with a cloud computing platform (such as an open cloud (O-Cloud) 290) to perform network element life cycle management (such as to instantiate virtualized network elements) via a cloud computing platform interface (such as an O2 interface). Such virtualized network elements can include, but are not limited to, CUs 210, DUs 230, RUs 240 and Near-RT RICs 225. In some implementations, the SMO Framework 205 can communicate with a hardware aspect of a 4G RAN, such as an open eNB (O-eNB) 211, via an O1 interface. Additionally, in some implementations, the SMO Framework 205 can communicate directly with one or more RUs 240 via an O1 interface. The SMO Framework 205 also may include a Non-RT RIC 215 configured to support functionality of the SMO Framework 205.

The Non-RT RIC 215 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 225. The Non-RT RIC 215 may be coupled to or communicate with (such as via an Al interface) the Near-RT RIC 225. The Near-RT RIC 225 may be configured to include a logical function that enables near-real-time control and optimization of RAN elements and resources via data collection and actions over an interface (such as via an E2 interface) connecting one or more CUs 210, one or more DUs 230, or both, as well as an O-eNB, with the Near-RT RIC 225.

In some implementations, to generate AI/ML models to be deployed in the Near-RT RIC 225, the Non-RT RIC 215 may receive parameters or external enrichment information from external servers. Such information may be utilized by the Near-RT RIC 225 and may be received at the SMO Framework 205 or the Non-RT RIC 215 from non-network data sources or from network functions. In some examples, the Non-RT RIC 215 or the Near-RT RIC 225 may be configured to tune RAN behavior or performance. For example, the Non-RT RIC 215 may monitor long-term trends and patterns for performance and employ AI/ML models to perform corrective actions through the SMO Framework 205 (such as reconfiguration via 01) or via creation of RAN management policies (such as A1 policies).

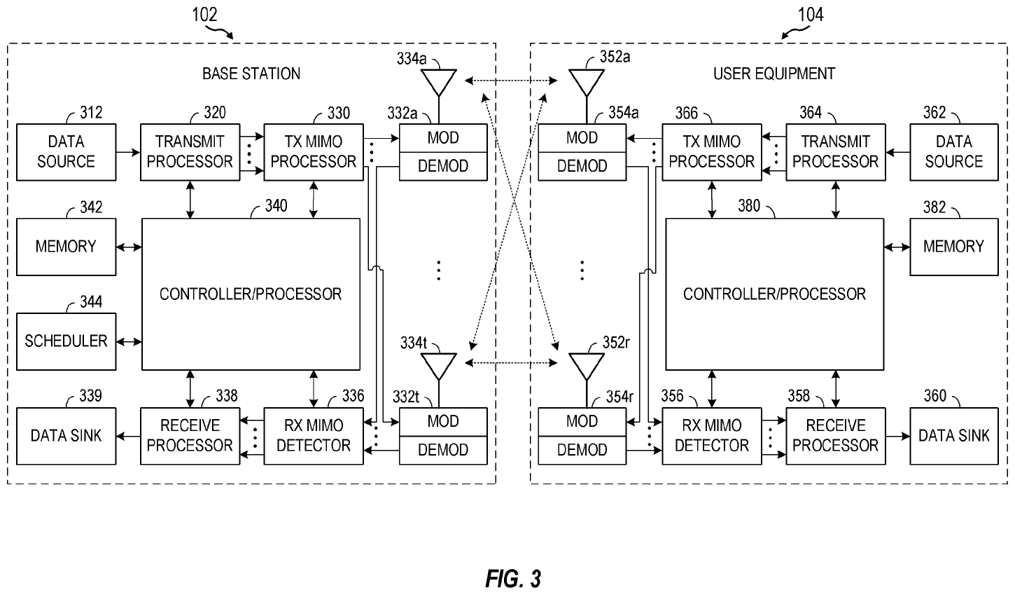

FIG. 3 depicts aspects of an example BS 102 and a UE 104.

Generally, BS 102 includes various processors (e.g., 320, 330, 338, and 340), antennas 334a-t (collectively 334), transceivers 332a-t (collectively 332), which include modulators and demodulators, and other aspects, which enable wireless transmission of data (e.g., data source 312) and wireless reception of data (e.g., data sink 339). For example, BS 102 may send and receive data between BS 102 and UE 104. BS 102 includes controller/processor 340, which may be configured to implement various functions described herein related to wireless communications.

Generally, UE 104 includes various processors (e.g., 358, 364, 366, and 380), antennas 352a-r (collectively 352), transceivers 354a-r (collectively 354), which include modulators and demodulators, and other aspects, which enable wireless transmission of data (e.g., retrieved from data source 362) and wireless reception of data (e.g., provided to data sink 360). UE 104 includes controller/processor 380, which may be configured to implement various functions described herein related to wireless communications.

In regards to an example downlink transmission, BS 102 includes a transmit processor 320 that may receive data from a data source 312 and control information from a controller/processor 340. The control information may be for the physical broadcast channel (PBCH), physical control format indicator channel (PCFICH), physical HARQ indicator channel (PHICH), physical downlink control channel (PDCCH), group common PDCCH (GC PDCCH), and/or others. The data may be for the physical downlink shared channel (PDSCH), in some examples.

Transmit processor 320 may process (e.g., encode and symbol map) the data and control information to obtain data symbols and control symbols, respectively. Transmit processor 320 may also generate reference symbols, such as for the primary synchronization signal (PSS), secondary synchronization signal (SSS), PBCH demodulation reference signal (DMRS), and channel state information reference signal (CSI-RS).

Transmit (TX) multiple-input multiple-output (MIMO) processor 330 may perform spatial processing (e.g., precoding) on the data symbols, the control symbols, and/or the reference symbols, if applicable, and may provide output symbol streams to the modulators (MODs) in transceivers 332a-332t. Each modulator in transceivers 332a-332t may process a respective output symbol stream to obtain an output sample stream. Each modulator may further process (e.g., convert to analog, amplify, filter, and upconvert) the output sample stream to obtain a downlink signal. Downlink signals from the modulators in transceivers 332a-332t may be transmitted via the antennas 334a-334t, respectively.

In order to receive the downlink transmission, UE 104 includes antennas 352a-352r that may receive the downlink signals from the BS 102 and may provide received signals to the demodulators (DEMODs) in transceivers 354a-354r, respectively. Each demodulator in transceivers 354a-354r may condition (e.g., filter, amplify, downconvert, and digitize) a respective received signal to obtain input samples. Each demodulator may further process the input samples to obtain received symbols.

MIMO detector 356 may obtain received symbols from all the demodulators in transceivers 354a-354r, perform MIMO detection on the received symbols if applicable, and provide detected symbols. Receive processor 358 may process (e.g., demodulate, deinterleave, and decode) the detected symbols, provide decoded data for the UE 104 to a data sink 360, and provide decoded control information to a controller/processor 380.

In regards to an example uplink transmission, UE 104 further includes a transmit processor 364 that may receive and process data (e.g., for the PUSCH) from a data source 362 and control information (e.g., for the physical uplink control channel (PUCCH)) from the controller/processor 380. Transmit processor 364 may also generate reference symbols for a reference signal (e.g., for the sounding reference signal (SRS)). The symbols from the transmit processor 364 may be precoded by a TX MIMO processor 366 if applicable, further processed by the modulators in transceivers 354a-354r (e.g., for SC-FDM), and transmitted to BS 102.

At BS 102, the uplink signals from UE 104 may be received by antennas 334a-t, processed by the demodulators in transceivers 332a-332t, detected by a MIMO detector 336 if applicable, and further processed by a receive processor 338 to obtain decoded data and control information sent by UE 104. Receive processor 338 may provide the decoded data to a data sink 339 and the decoded control information to the controller/processor 340.

Memories 342 and 382 may store data and program codes for BS 102 and UE 104, respectively.

Scheduler 344 may schedule UEs for data transmission on the downlink and/or uplink.

In various aspects, BS 102 may be described as transmitting and receiving various types of data associated with the methods described herein. In these contexts, “transmitting” may refer to various mechanisms of outputting data, such as outputting data from data source 312, scheduler 344, memory 342, transmit processor 320, controller/processor 340, TX MIMO processor 330, transceivers 332a-t, antenna 334a-t, and/or other aspects described herein. Similarly, “receiving” may refer to various mechanisms of obtaining data, such as obtaining data from antennas 334a-t, transceivers 332a-t, RX MIMO detector 336, controller/processor 340, receive processor 338, scheduler 344, memory 342, and/or other aspects described herein.

In various aspects, UE 104 may likewise be described as transmitting and receiving various types of data associated with the methods described herein. In these contexts, “transmitting” may refer to various mechanisms of outputting data, such as outputting data from data source 362, memory 382, transmit processor 364, controller/processor 380, TX MIMO processor 366, transceivers 354a-t, antenna 352a-t, and/or other aspects described herein. Similarly, “receiving” may refer to various mechanisms of obtaining data, such as obtaining data from antennas 352a-t, transceivers 354a-t, RX MIMO detector 356, controller/processor 380, receive processor 358, memory 382, and/or other aspects described herein.

In some aspects, a processor may be configured to perform various operations, such as those associated with the methods described herein, and transmit (output) to or receive (obtain) data from another interface that is configured to transmit or receive, respectively, the data.

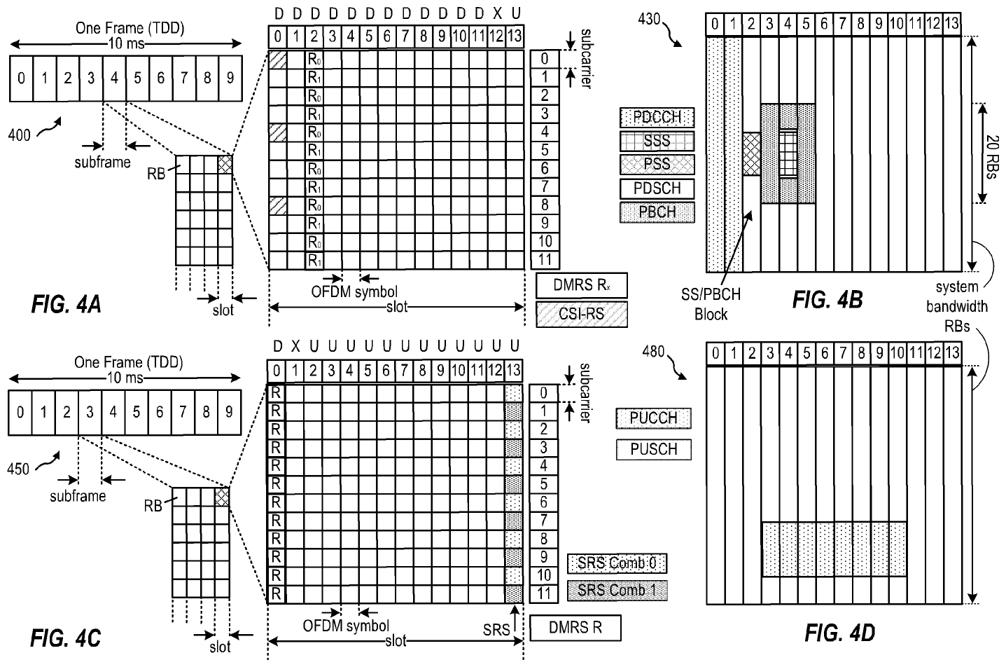

FIGS. 4A, 4B, 4C, and 4D depict aspects of data structures for a wireless communications network, such as wireless communications network 100 of FIG. 1.

In particular, FIG. 4A is a diagram 400 illustrating an example of a first subframe within a 5G (e.g., 5G NR) frame structure, FIG. 4B is a diagram 430 illustrating an example of DL channels within a 5G subframe, FIG. 4C is a diagram 450 illustrating an example of a second subframe within a 5G frame structure, and FIG. 4D is a diagram 480 illustrating an example of UL channels within a 5G subframe.

Wireless communications systems may utilize orthogonal frequency division multiplexing (OFDM) with a cyclic prefix (CP) on the uplink and downlink. Such systems may also support half-duplex operation using time division duplexing (TDD). OFDM and single-carrier frequency division multiplexing (SC-FDM) partition the system bandwidth (e.g., as depicted in FIGS. 4B and 4D) into multiple orthogonal subcarriers. Each subcarrier may be modulated with data. Modulation symbols may be sent in the frequency domain with OFDM and/or in the time domain with SC-FDM.

A wireless communications frame structure may be frequency division duplex (FDD), in which, for a particular set of subcarriers, subframes within the set of subcarriers are dedicated for either DL or UL. Wireless communications frame structures may also be time division duplex (TDD), in which, for a particular set of subcarriers, subframes within the set of subcarriers are dedicated for both DL and UL.

In FIG. 4A and 4C, the wireless communications frame structure is TDD where D is DL, U is UL, and Xis flexible for use between DL/UL. UEs may be configured with a slot format through a received slot format indicator (SFI) (dynamically through DL control information (DCI), or semi-statically/statically through radio resource control (RRC) signaling). In the depicted examples, a 10 ms frame is divided into 10 equally sized 1 ms subframes. Each subframe may include one or more time slots. In some examples, each slot may include 7 or 14 symbols, depending on the slot format. Subframes may also include mini-slots, which generally have fewer symbols than an entire slot. Other wireless communications technologies may have a different frame structure and/or different channels.

In certain aspects, the number of slots within a subframe is based on a slot configuration and a numerology. For example, for slot configuration 0, different numerologies (μ) 0 to 5 allow for 1, 2, 4, 8, 16, and 32 slots, respectively, per subframe. For slot configuration 1, different numerologies 0 to 2 allow for 2, 4, and 8 slots, respectively, per subframe. Accordingly, for slot configuration 0 and numerology u, there are 14 symbols/slot and 2μ slots/subframe. The subcarrier spacing and symbol length/duration are a function of the numerology. The subcarrier spacing may be equal to 2^{μ}×15 kHz, where μ is the numerology 0 to 5. As such, the numerology μ=0 has a subcarrier spacing of 15 kHz and the numerology μ=5 has a subcarrier spacing of 480 kHz. The symbol length/duration is inversely related to the subcarrier spacing. FIGS. 4A, 4B, 4C, and 4D provide an example of slot configuration 0 with 14 symbols per slot and numerology μ=2 with 4 slots per subframe. The slot duration is 0.25 ms, the subcarrier spacing is 60 kHz, and the symbol duration is approximately 16.67 μs.

As depicted in FIGS. 4A, 4B, 4C, and 4D, a resource grid may be used to represent the frame structure. Each time slot includes a resource block (RB) (also referred to as physical RBs (PRBs)) that extends, for example, 12 consecutive subcarriers. The resource grid is divided into multiple resource elements (REs). The number of bits carried by each RE depends on the modulation scheme.

As illustrated in FIG. 4A, some of the REs carry reference (pilot) signals (RS) for a UE (e.g., UE 104 of FIGS. 1 and 3). The RS may include demodulation RS (DMRS) and/or channel state information reference signals (CSI-RS) for channel estimation at the UE. The RS may also include beam measurement RS (BRS), beam refinement RS (BRRS), and/or phase tracking RS (PT-RS).

FIG. 4B illustrates an example of various DL channels within a subframe of a frame. The physical downlink control channel (PDCCH) carries DCI within one or more control channel elements (CCEs), each CCE including, for example, nine RE groups (REGs), each REG including, for example, four consecutive REs in an OFDM symbol.

A primary synchronization signal (PSS) may be within symbol 2 of particular subframes of a frame. The PSS is used by a UE (e.g., 104 of FIGS. 1 and 3) to determine subframe/symbol timing and a physical layer identity.

A secondary synchronization signal (SSS) may be within symbol 4 of particular subframes of a frame. The SSS is used by a UE to determine a physical layer cell identity group number and radio frame timing.

Based on the physical layer identity and the physical layer cell identity group number, the UE can determine a physical cell identifier (PCI). Based on the PCI, the UE can determine the locations of the aforementioned DMRS. The physical broadcast channel (PBCH), which carries a master information block (MIB), may be logically grouped with the PSS and SSS to form a synchronization signal (SS)/PBCH block. The MIB provides a number of RBs in the system bandwidth and a system frame number (SFN). The physical downlink shared channel (PDSCH) carries user data, broadcast system information not transmitted through the PBCH such as system information blocks (SIBs), and/or paging messages.

As illustrated in FIG. 4C, some of the REs carry DMRS (indicated as R for one particular configuration, but other DMRS configurations are possible) for channel estimation at the base station. The UE may transmit DMRS for the PUCCH and DMRS for the PUSCH. The PUSCH DMRS may be transmitted, for example, in the first one or two symbols of the PUSCH. The PUCCH DMRS may be transmitted in different configurations depending on whether short or long PUCCHs are transmitted and depending on the particular PUCCH format used. UE 104 may transmit sounding reference signals (SRS). The SRS may be transmitted, for example, in the last symbol of a subframe. The SRS may have a comb structure, and a UE may transmit SRS on one of the combs. The SRS may be used by a base station for channel quality estimation to enable frequency-dependent scheduling on the UL.

FIG. 4D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), and/or UCI.

### Overview of Timing Advance for mTRP

Current wireless systems support multiple transmission reception point (mTRP) signaling based on single or multiple downlink control information (DCI) transmissions. In the single DCI scenario, a single DCI is sent to schedule an mTRP transmission. In the multiple DCI scenario, each TRP sends a separate DCI.

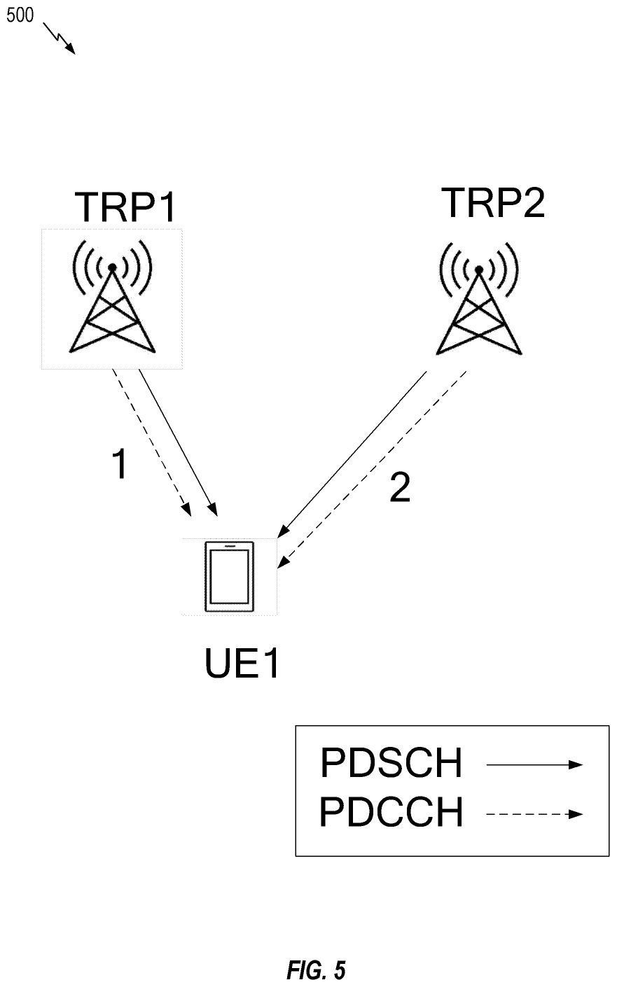

As illustrated in the mTRP scenario shown in FIG. 5, a first DCI (conveyed via PDCCH1) transmitted from a first TRP (TRP1) may schedule a first physical downlink shared channel (PDSCH) (PDSCH of 1) transmitted from TRP1. A second DCI (conveyed via PDCCH2) transmitted from a second TRP (TRP2) schedules a second PDSCH (PDSCH of 2) transmitted from TRP2.

Differentiation of TRPs may be performed by a user equipment (UE) based on a pool index value defined within a control resource set (CORESET) for each TRP (e.g., a CORESETPoolIndex). In many cases, the UE will be configured with multi-DCI based multi-TRP in a given component carrier (CC). Each CORESET may be configured with a value of CORESETPoolIndex. In many cases, a maximum of five CORESETs may be configured.

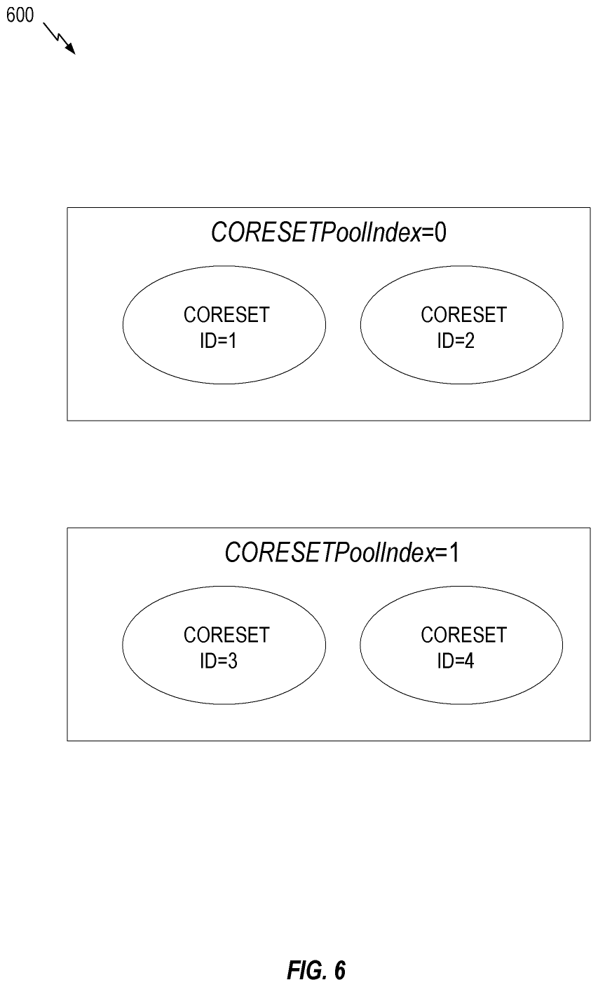

As illustrated in FIG. 6, the value of CORESETPoolIndex may be assigned an ID of 0 or 1. The CORESETPoolIndex value may group the CORESETs into two groups. For example, CORESETs with CORESET IDs 1 and 2 may be grouped when CORESETPoolIndex equals zero. CORESETs with CORESET IDs 3 and 4 may be grouped when CORESETPoolIndex equals one. In many cases, a UE may be able to distinguish TRPs from one another. In some cases, a UE may be configured by a higher layer parameter (e.g., PDCCH-Config) that contains two different values of CORESETPoolIndex in each CORESET for the active bandwidth part (BWP) of a serving cell. In many cases, the CORESETPoolIndex of the CORESET in which a DCI is received may be used for different purposes. For instance, the CORESETPoolIndex may be used for hybrid automatic repeat request (HARQ) acknowledgement (ACK) feedback.

In the current systems, each serving cell may be associated with one TAG. In other words, there may one TAG identifier (ID) configured for a serving cell and only one timing advance (TA) value may be used for uplink (UL) transmission on that serving cell.

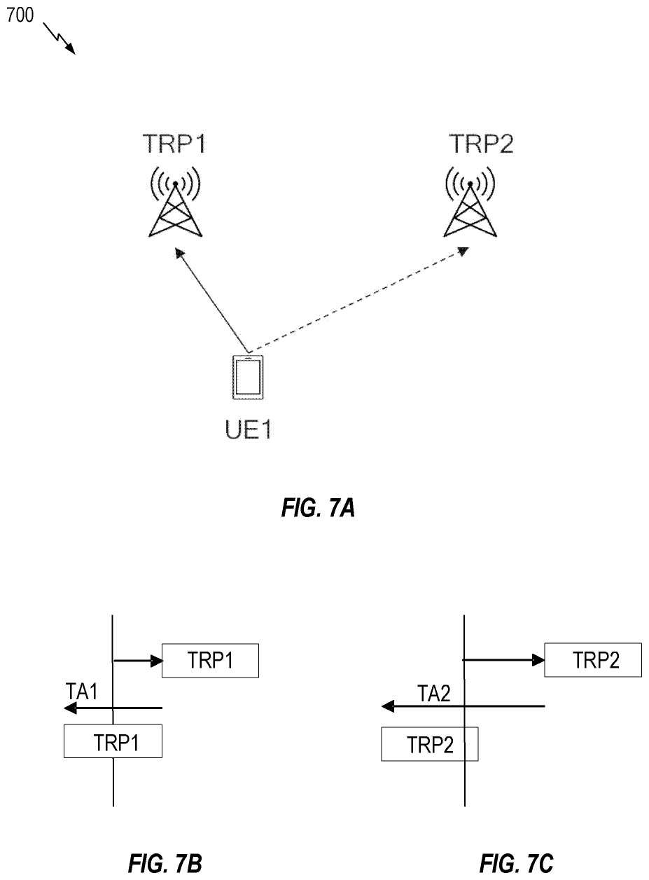

For an mTRP scenario, such as that shown in FIG. 7A, where a UE transmits to a first and second TRP according to configured scheduling, it may be desirable to allow each TRP to belong to a different TAG. As noted above, a UE may be configured with two TAs for UL multi-DCI transmission for multi-TRP operation. Taking into account different propagation delays from various TRPs, a UE may apply different TAs for UL transmission to different TRPs. In some cases, there may be different TAG IDs for a serving cell. Each different TA may be associated with a certain TRP.

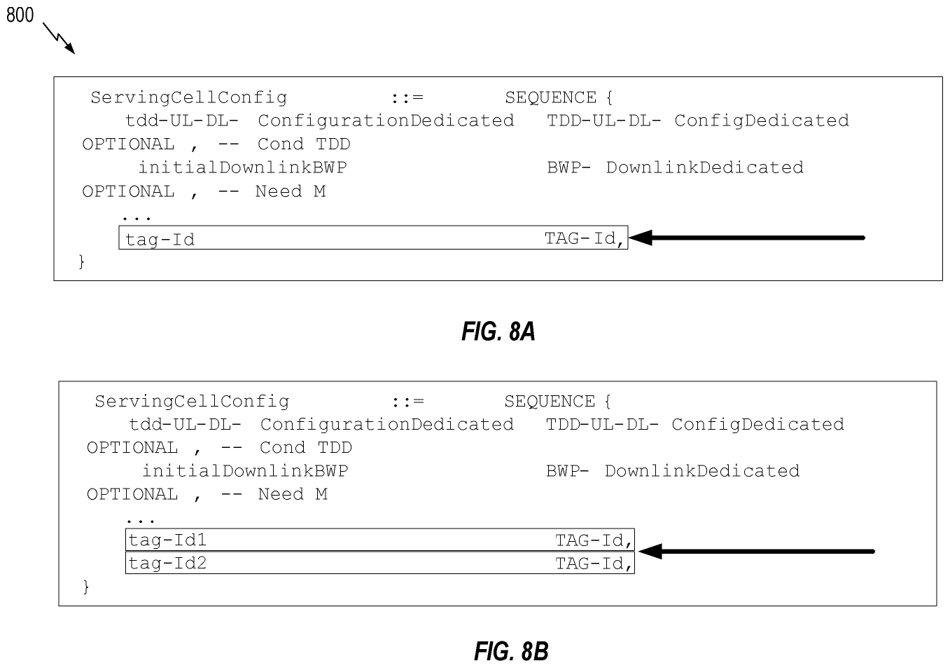

Accordingly, different TRPs may have different TA values for UL transmission as illustrated in FIGS. 7B and 7C, with TAI used for transmissions to TRP1 and TA2 used for transmissions to TRP2. As a result, scheduled UL transmission may overlap in time. FIG. 8A illustrates how, in some systems (e.g., NR Rel. 15/16/17), each serving cell may be associated with one TAG (and one TA value is used for uplink transmissions). In contrast, FIG. 8B illustrates how in some systems (e.g., per NR Rel. 18), two TAs (associated with different TAGs, with tag-ID1 and tag-ID2) may be specified for UL multi-DCI for multi-TRP operation. In this case, different TRPs may have different TA values (associated with the different TAGs).

For UL transmission of various channels and signals, such as physical uplink control channel (PUCCH), physical uplink shared channel (PUSCH), and sounding reference signal (SRS), when multiple TAGs are configured, each UL transmission may be associated with a given TAG. The association between the UL transmission and the given TAG may be determined based on at least one of the following: the CORESETPoolIndex value associated with the PUCCH/PUSCH/SRS, the CloseLoopIndex value associated with PUCCH/PUSCH/SRS, and the SRS resource set index associated with PUSCH/SRS.

In some cases, a two-level priority may be assigned for uplink channel (e.g., high priority and low priority). Priorities may be defined and indicated by at least one of the following: scheduling request (SR)-PUCCH and beam failure recovery (BFR)-PUCCH by radio resource control (RRC) signaling, periodic channel state information (P-CSI), semi-periodic CSI (SP-CSI), P-SRS, SP-SRS (which may be lower priority), HARQ-PUCCH for dynamically scheduled PDSCH by DCI, HARQ-PUCCH for semi-persistent scheduling (SPS) PDSCH by RRC signaling, dynamically granted PUSCH and aperiodic CSI (A-CSI) by DCI signaling, and a configured grant PUSCH by RRC signaling.

In some cases, the timing of UL transmission scheduling may be defined with respect to either logical or actual time. In this contest, logical time generally refers to the assumption that each of the following is assumed to be equal to zero: DL-to-DL timing differences between CCs, UL-to-UL timing differences across different TAGs, and UL timing advance. In contrast, actual time generally refers to the reality that actual values observed by the UE are not assumed to be zero, but rather: DL-to-DL timing differences between CCs, UL-to-UL timing differences across different TAGs, and UL timing advance.

In current systems, logical time is assumed when determining whether uplink transmissions overlap and when applying a dropping a rule for overlapping UL channels, while actual time is assumed for multiplexing a timeline.

In cases where overlapping UL transmissions comprise PUCCH and SRS on the same carrier, various dropping rules may be applied. For example, according to a first rule, if a PUCCH carries only CSI report(s), only layer one (L1) reference signal received power (L1-RSRP) report(s), or only L1 signal to interference plus noise (L1-SINR) report(s) overlapping in time with semi-persistent SRS or periodic SRS, then the UE may drop SRS in the symbol(s) that overlap with the PUCCH. According to a second rule, if the PUCCH carries a HARQ-ACK, link recovery request, and/or SR overlapping with semi-persistent SRS, periodic SRS or aperiodic SRS, the UE may drop SRS in the symbol(s) that overlap with the PUCCH. According to a third rule, if PUCCH carries semi-persistent/periodic CSI report(s), semi-persistent/periodic L1-RSRP reports only, or only L1-SINR reports overlapping with aperiodic SRS, the PUCCH is dropped. In summary, PUCCH with HARQ-ACK typically has priority over aperiodic SRS which, in turn, typically has priority over PUCCH with CSI which, in turn, typically has priority over semi-persistent/periodic SRS.

In cases where overlapping UL transmissions comprise a first SRS and a second SRS on the same carrier a different set of dropping rules may be applied For example, if aperiodic SRS overlaps in time with periodic/semi-persistent SRS, the UE may drop the periodic/semi-persistent SRS in the symbol(s) that overlap with aperiodic SRS. As another example, if semi-persistent SRS overlaps in time with periodic SRS, the UE may drop the periodic SRS in the symbol(s) that overlaps in time with semi-persistent SRS. In summary, aperiodic SRS typically has priority over semi-persistent SRS which, in turn, typically has priority over periodic SRS.

Based on the dropping rules described above, the combined priority ranking between PUCCH/SRS and SRS is typically as follows, starting with highest priority: PUCCH with HARQ-ACK aperiodic SRS, PUCCH with CSI, semi-persistent SRS, and periodic SRS.

A UE may have limited support for handling SRS and PUCCH/PUSCH on different CCs. For example, for intra-band or inter-band carrier aggregation (CA), the UE may not expected to be configured with SRS from a CC overlapping in time with PUSCH/UL, demodulation reference signal (DMRS)/UL, and phase tracking reference signal (PTRS)/PUCCH on another CC, if the UE is not capable of simultaneous SRS and PUCCH/PUSCH (e.g., and the UE may treat this is an error case).

For SRS and physical random access channel (PRACH) transmissions on different CCs, if a UE is not capable of simultaneous SRS and PRACH transmissions, the UE may drop SRS on a CC and transmit a physical random access procedure (PRACH) in another CC. In some cases, for low priority PUSCH and SRS on a same CC, if low priority PUSCH and SRS are to be transmitted in the same slot, the UE may be configured to transmit SRS after PUSCH. For high-priority PUSCH/PUCCH and SRS on the same CC, if high-priority PUSCH/PUCCH and SRS overlap in time, the UE may drop the SRS in the overlapping symbol(s).

### Aspects Related to Handling Overlap Across Different TAGS

Aspects of the present disclosure describe techniques for handling overlapping UL transmission across different TA groups. The techniques may help address different scenarios where overlapping (or potentially overlapping) uplink transmissions are scheduled for TRPs belonging to different TRP groups.

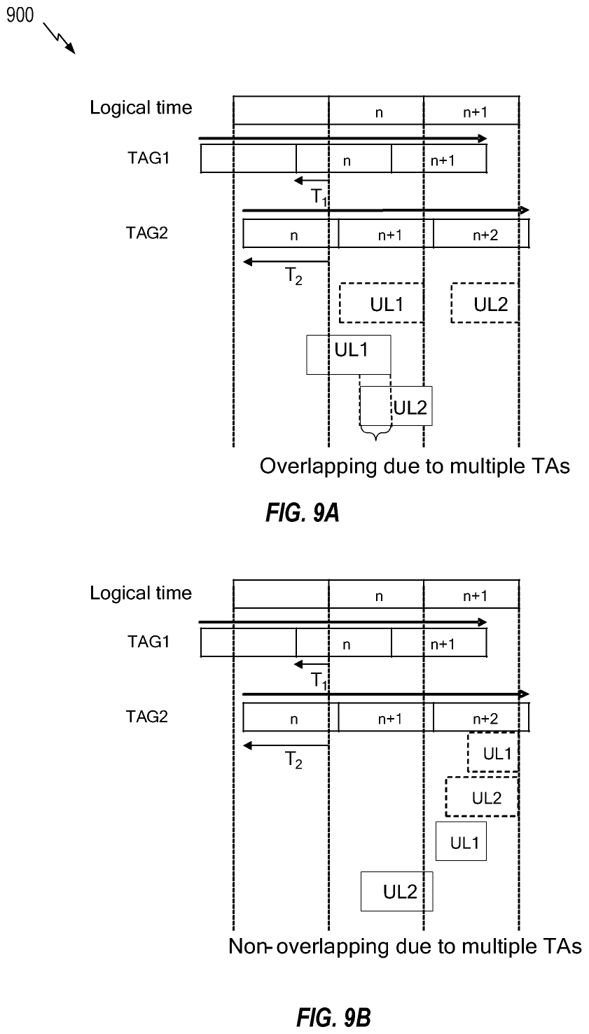

For example, such scenarios may arise when two TAs are configured for at least one CC (e.g., a CC is configured with multiple CORESETPoolIndex values), different TAs may be used for UL transmission (e.g., PUSCH/PUCCH/SRS) towards different TRPs. In a first case, as illustrated in FIG. 9A, non-overlapping UL transmission based on logical time may be overlapping in actual time due to different timing advances. For example, in the figure, T₁ is the timing advance value associated with TAG1 with respect to the logical time. T₂ is the timing advance value associated with TAG2 with respect to the logical time. T₁ and T₂ are used for the purpose of illustration. In practice, the timing advance may be with respect to a DL reference time rather than the logical time. In a second case, as illustrated in FIG. 9B, overlapping UL transmissions based on logical time may be non-overlapping in actual time due to different TAs. This second case may be less problematic, as long as the issue of transmissions overlapping in logical time is resolved. For the first case, however an issue arises when the UL transmissions overlap in actual time and the UE is not capable of simultaneous UL transmissions.

Aspects of the present disclosure provide techniques for handling overlapping UL channels and signals across different TAGs for various such cases. For example, the techniques may help handle one or more of a first case where SRS overlaps in actual time with SRS associated with a different TAG, a second case where an SRS overlaps in actual time with a PUCCH associated with a different TAG, a third case where SRS overlaps in actual time with a PUSCH associated with a different TAG, a fourth case where an SRS/PUCCH/PUSCH overlaps in actual time with a PRACH associated with a different TAG, and a fifth case where a PUCCH/PUSCH overlaps in actual time with a PUCCH/PUSCH associated with different TAG.

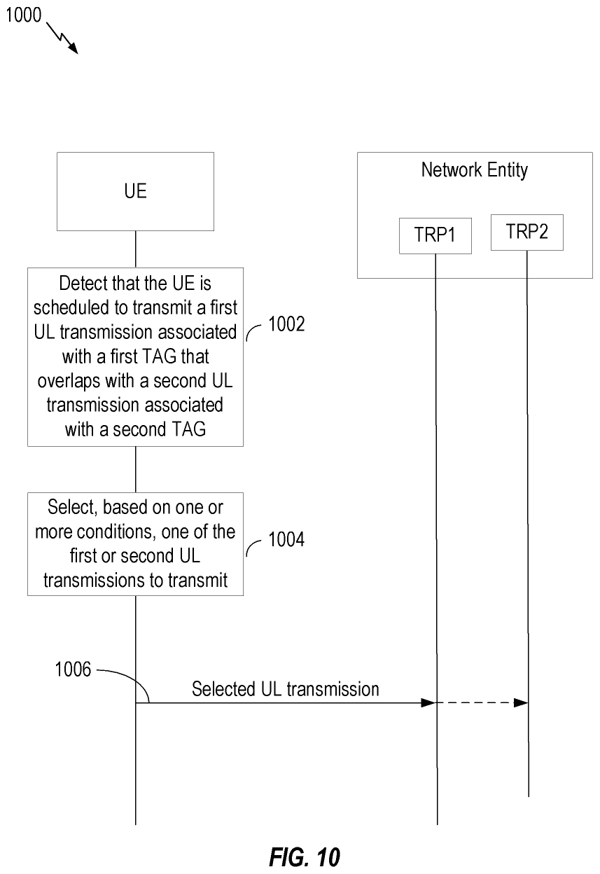

Aspects of the present disclosure may be understood with reference to the call flow diagram 1000 of FIG. 10, which depicts a UE in an mTRP deployment with TRP1 and TRP2. In some aspects, the network entity (and/or each TRP) may be an example of the BS 102 depicted and described with respect to FIGS. 1 and 3 or a disaggregated base station depicted and described with respect to FIG. 2. Similarly, the UE may be an example of UE 104 depicted and described with respect to FIGS. 1 and 3. However, in other aspects, UE 104 may be another type of wireless communications device and BS 102 may be another type of network entity or network node, such as those described herein.

At 1002, the UE detects that the UE is scheduled to transmit a first UL transmission associated with a first TAG that overlaps with a second UL transmission associated with a second TAG. At 1004, selects one of the first or second UL transmissions to transmit, based on one or more conditions. At 1006, the UE transmits the selected UL transmission (e.g., to TRP1 or TRP2).

As illustrated, to implement techniques described herein for handling overlapping UL channels and signals across different TAGs, the UE may determine that two overlapping UL transmissions associated with different TAGs are to be transmitted in a same CC or different CCs. The first UL transmission may be associated with a first TAG, and the second UL transmission may be associated with a second TAG.

An overlap of the first UL transmission and the second UL transmission may be determined after applying an UL TA for each UL transmission. In some cases, the UE may not be capable of simultaneous transmission for the two UL transmissions on the same CC or different CCs. In such cases, after applying UL TAs to each of the transmissions, the UE may determine which of the two UL transmissions are transmitted based on a set of rules described herein, which may depend on the signal or channel type and/or priority of the UL transmissions.

For example, when both the first UL transmission and the second UL transmission are SRSs, the UE may select one of the UL transmissions based on at least one of the following conditions. In one case, the UE may select a UL based on the time domain behavior (e.g., periodic-P, semi-persistent-SP, or aperiodic-A) of the SRS. In such cases, A-SRS may be prioritized over SP-SRS which, in turn, may be prioritized over P-SRS.

If the first UL SRS and the second SRS have the same time domain behavior, various actions may be considered. For example, the UE may treat this as an error case. As another example, the UE may select the SRS with an earlier starting time (e.g., actual or logical time). As still another example, the UE may select the SRS associated with lowest/highest TAG index, or the UE may select the SRS with TAG index associated with the lowest or highest CORESETPoolIndex value, the lowest or highest closeLoopIndex value, or the lowest or highest SRS resource set index.

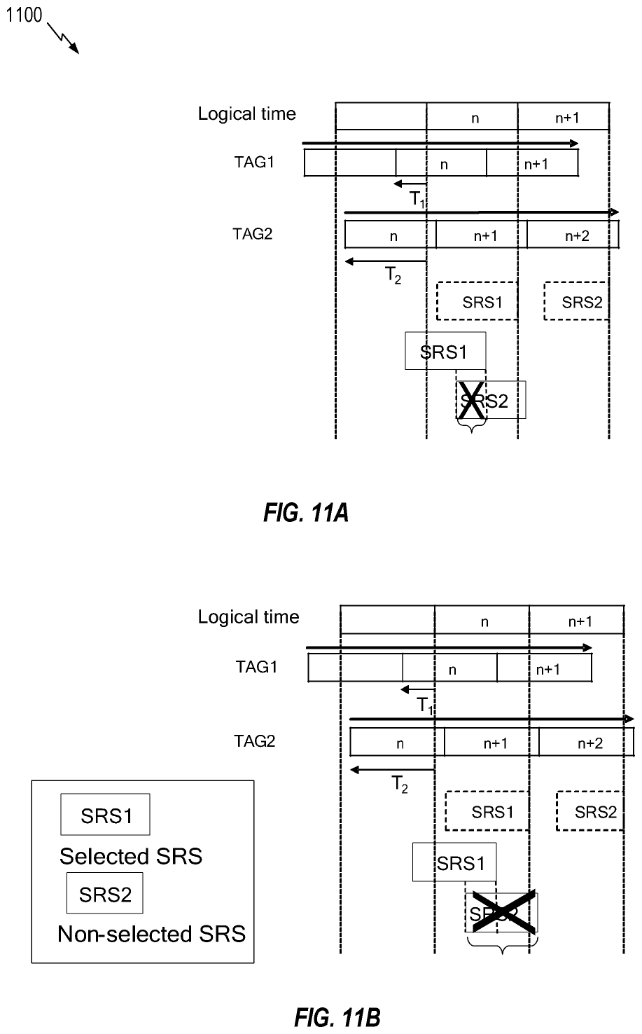

In some cases, the UE may transmit the selected SRS and only drop the overlapping portion of the non-selected SRS. For example, as illustrated in FIG. 11A, the UE may drop the non-selected SRS in overlapping symbols while transmitting the non-selected SRS in non-overlapping symbols. In another case, the UE may drop the entire non-selected SRS, as illustrated in FIG. 11B.

The UE may also apply dropping rules when the first UL transmission is SRS and the second UL transmission is PUCCH. In such cases, the UE may select one of the UL based on various conditions. For example, if the first UL transmission and the second UL transmission are associated with the same priority index, the UE may select a UL transmission based on the uplink control information (UCI) type of the PUCCH. In this case, PUCCH with HARQ-ACK may be prioritized over aperiodic SRS which, in turn, may be prioritized over PUCCH with CSI which, in turn, may be prioritized over semi-persistent/periodic SRS. As another example, if the first UL transmission and the second transmission are associated with different priority index values, the UE may select a UL transmission with higher priority index (e.g., an UL transmission associated with priority index 1 may be selected over an UL transmission associated with priority index 0).

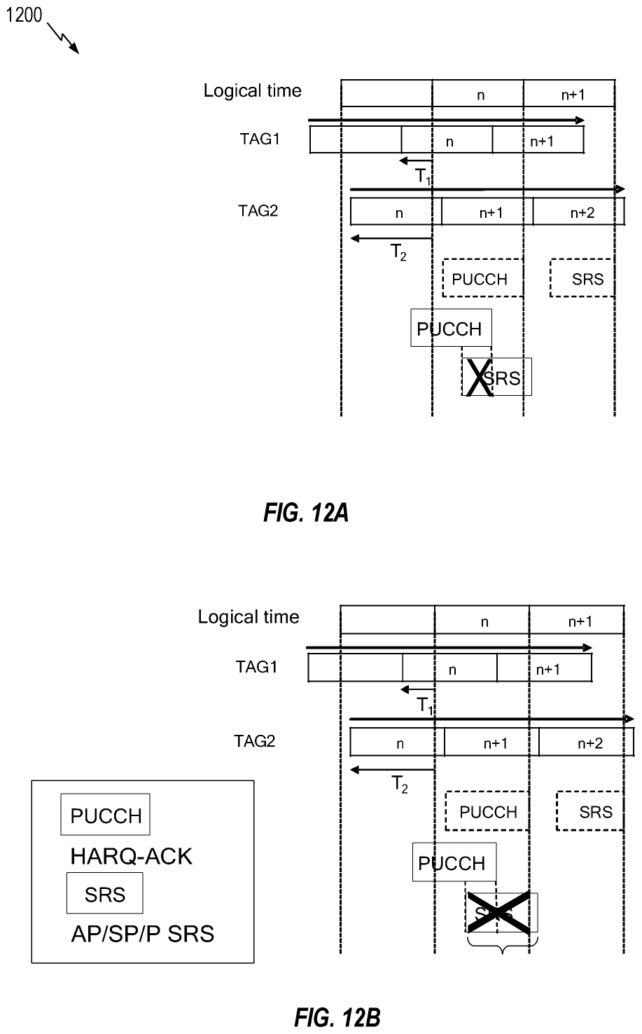

In some case, the UE may transmit the selected UL and drop the non-selected UL in overlapping symbols while transmit the non-selected UL in non-overlapping symbols, as illustrated in FIG. 12A. In other cases, the UE may transmit the selected UL and drops the whole of the non-selected UL as illustrated in FIG. 12B.

The UE may also apply dropping rules when the first UL transmission is SRS and the second UL transmission is PUSCH. For example, if the first UL transmission and the second UL transmission are associated with the same priority index, the UE may select PUSCH. If the first UL transmission and the second transmission are associated with different priority index values, the UE may select the UL transmission with higher priority index.

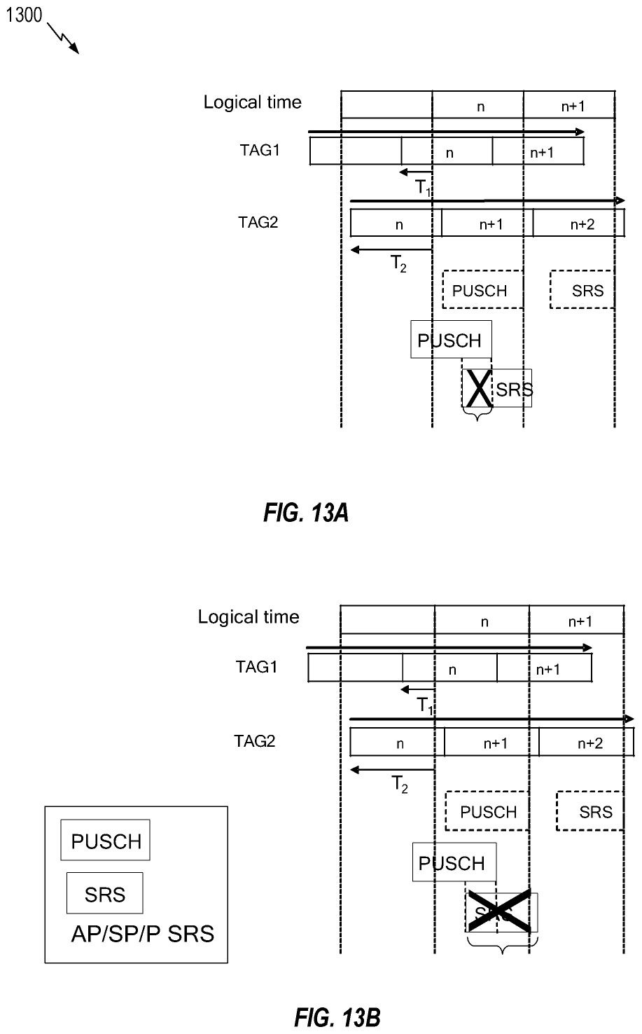

In some cases, the UE may transmit the selected UL and drops the non-selected UL in overlapping symbols while transmit the non-selected UL in non-overlapping symbols, as illustrated in FIG. 13A. In other cases, the UE may transmit the selected UL and drops the whole of the non-selected UL as illustrated in FIG. 13B.

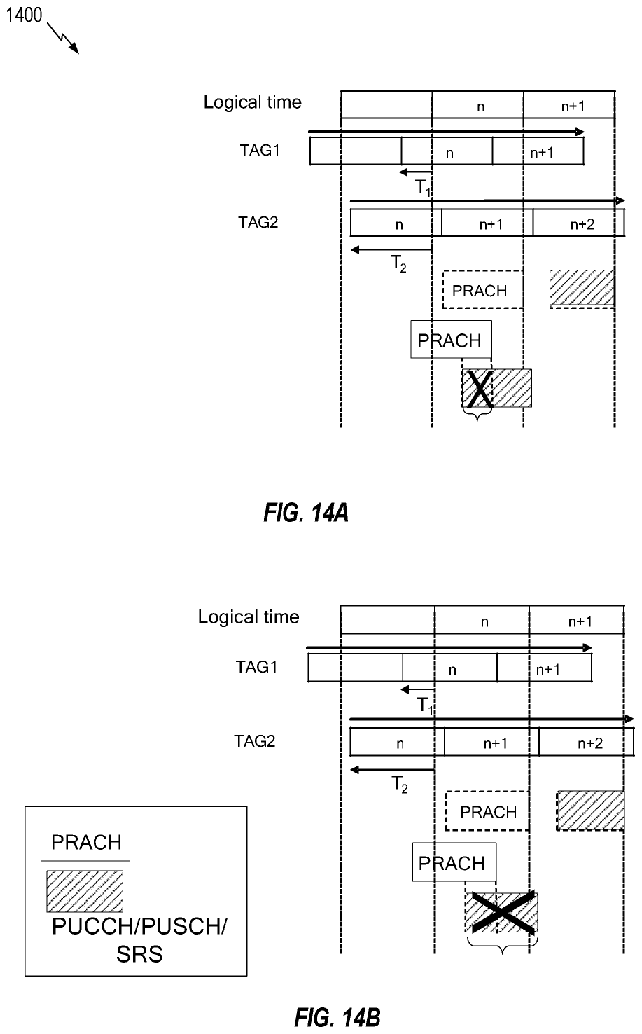

The UE may also apply dropping rules when the first UL transmission is SRS/PUCCH/PUSCH and the second UL transmission is PRACH. For example, the UE may transmit PRACH and drop SRS in overlapping symbols, while transmitting the SRS in non-overlapping symbols as illustrated in FIG. 14A. As an alternative, the UE may transmit PRACH and drop the entire SRS as illustrated in FIG. 14B.

In some cases, when the first UL transmission is SRS/PUCCH/PUSCH and the second UL transmission is PRACH, the UE may determine the association between PRACH and TAG when TA=0 is assumed for PRACH. In one case, PRACH may be associated with one of the TAGs of the serving cell where PRACH is transmitted. In such cases, the association between PRACH and a TAG index may be determined based on various criteria. For example, the association between PRACH and a TAG index may be based on the CORESETPoolIndex value of the PDCCH order that triggers the PRACH transmission, based on the SSB index that is associated with the RACH occasion of the PRACH transmission, or a default TAG index is assumed for the PRACH transmission (e.g., lowest or highest TAG index of the serving cell on which PRACH is transmitted is assumed as the default TAG index).

In such cases, when the PRACH and SRS/PUCCH/PUSCH potentially overlap in actual time, the UE may take various actions. For example, according to a first option, the UE may not transmit PRACH and SRS/PUCCH/PUSCH when there exists a gap in logical time between PRACH and SRS/PUCCH/PUSCH less than a threshold. In other words, a gap needs to be ensured by a network entity for the same TAG. The threshold may be hardcoded or configured via RRC signalling. Alternatively, if PRACH and SRS/PUCCH/PUSCH are overlapping in actual time, the UE may apply actions described in FIGS. 14A and 14B to this same TAG case.

According to a second option, PRACH may not be associated with any of the TAGs of the serving cell where PRACH is transmitted. In other words, the UE may essentially assume that PRACH is always associated with a different TAG than SRS/PUCCH/PUSCH.

The UE may also apply dropping rules when the first UL transmission is PUCCH/PUSCH and the second UL transmission is PUCCH/PUSCH. For example, if the first UL transmission and the second UL transmission are associated with the same priority index, the UE may select a UL transmission based on the content of the PUCCH/PUSCH. In this case, the HARQ-ACK/SR may be prioritized over CSI which, in turn, may be prioritized over data. If the first UL transmission and the second UL transmission have the same content, the UE may take one or more actions. For example, the UE may treat this as error case. As another example, the UE may select the PUCCH/PUSCH with earlier starting time (e.g., actual or logical time), the UE may select the PUCCH/PUSCH associated with lowest/highest TAG index, or the UE may select the PUCCH/PUSCH with a TAG index associated with the lowest or highest CORESETPoolIndex value, the lowest or highest closeLoopIndex value, or the lowest or highest SRS resource set index.

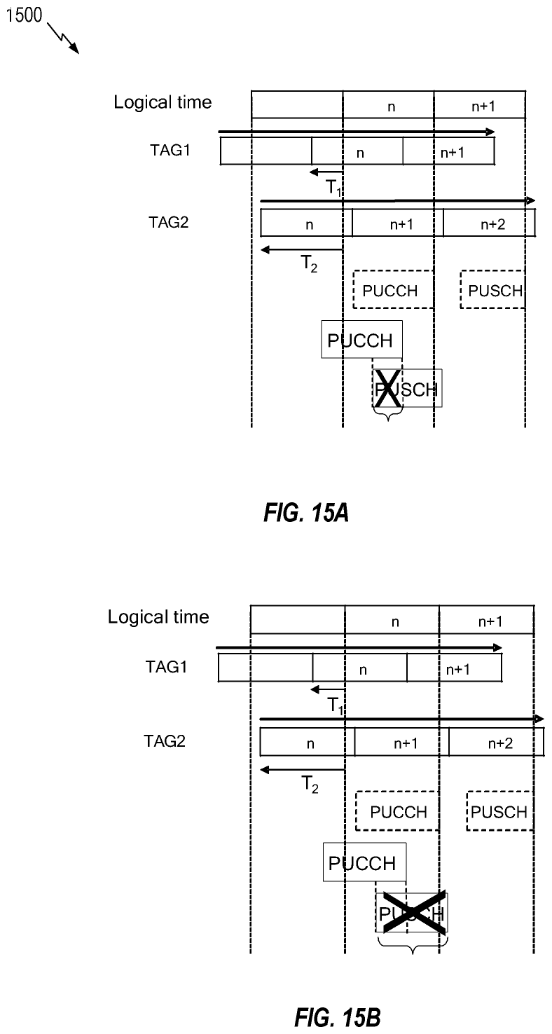

In some cases, if the first UL transmission and the second UL transmission are associated with different priority index values, the UE may select the UL transmission with the higher priority index. In one case, the UE may transmit the selected UL and drop the non-selected UL in overlapping symbols while transmitting the non-selected UL in non-overlapping symbols, as illustrated in FIG. 15A. In another case, the UE may transmit the selected UL and drop the entire (all symbols) of the non-selected UL, as illustrated in FIG. 15B.

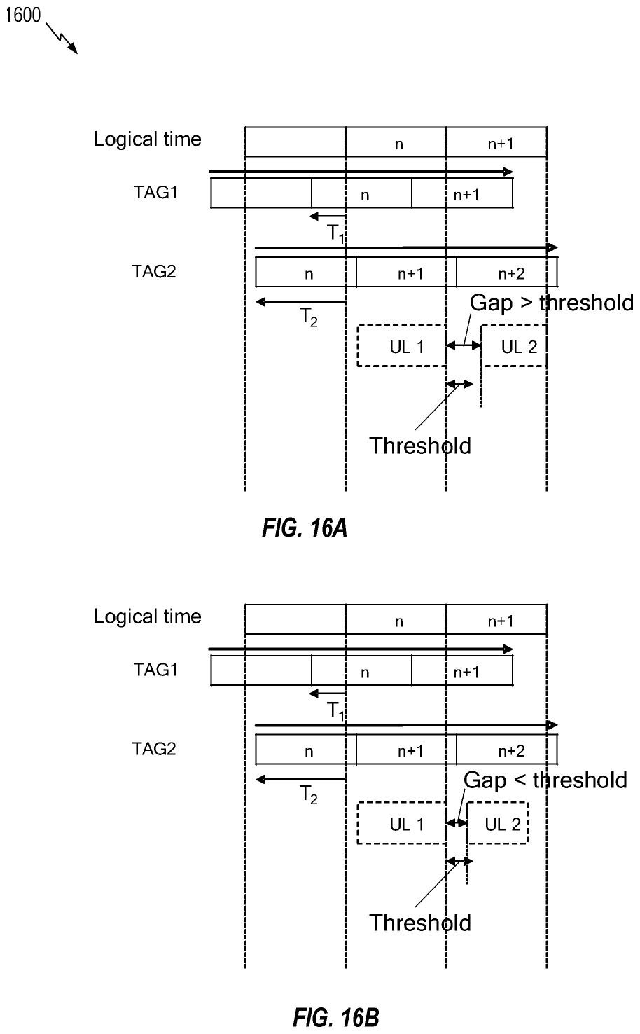

According to certain aspects of the present disclosure, the UE may expect at least a certain size gap (e.g., guard symbols, duration) between the first UL transmission and the second UL transmission in logical time. For example, the UE may expect the gap to be greater than a threshold value, as illustrated in FIG. 16A. If the gap between the first UL transmission and the second UL transmission is less than the threshold, as illustrated in FIG. 16B, the UE may take certain action. For example, the UE may consider these UL transmissions as potentially overlapping and may apply any of the various dropping rules described above.

### Example Operations of a User Equipment

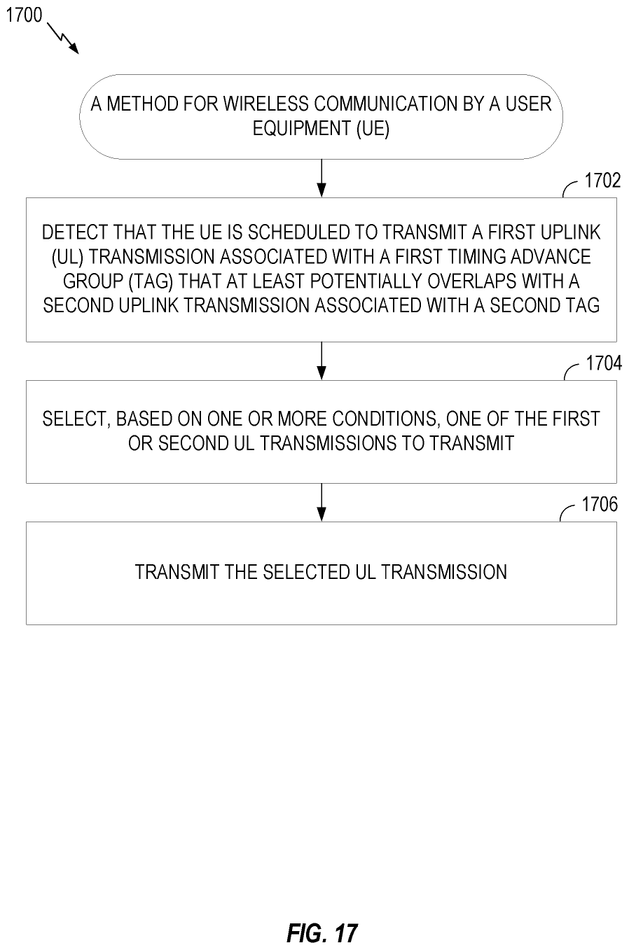

FIG. 17 shows a method 1700 for wireless communications by a UE, such as UE 104 of FIGS. 1 and 3.

Method 1700 begins at 1710 with the UE detecting that the UE is scheduled to transmit a first UL transmission associated with a first TAG that at least potentially overlaps with a second uplink transmission associated with a second TAG.

Method 1700 then proceeds to step 1720 with the UE selecting, based on one or more conditions, one of the first or second UL transmissions to transmit.

Method 1700 then proceeds to step 1730 the UE transmitting the selected UL transmission.

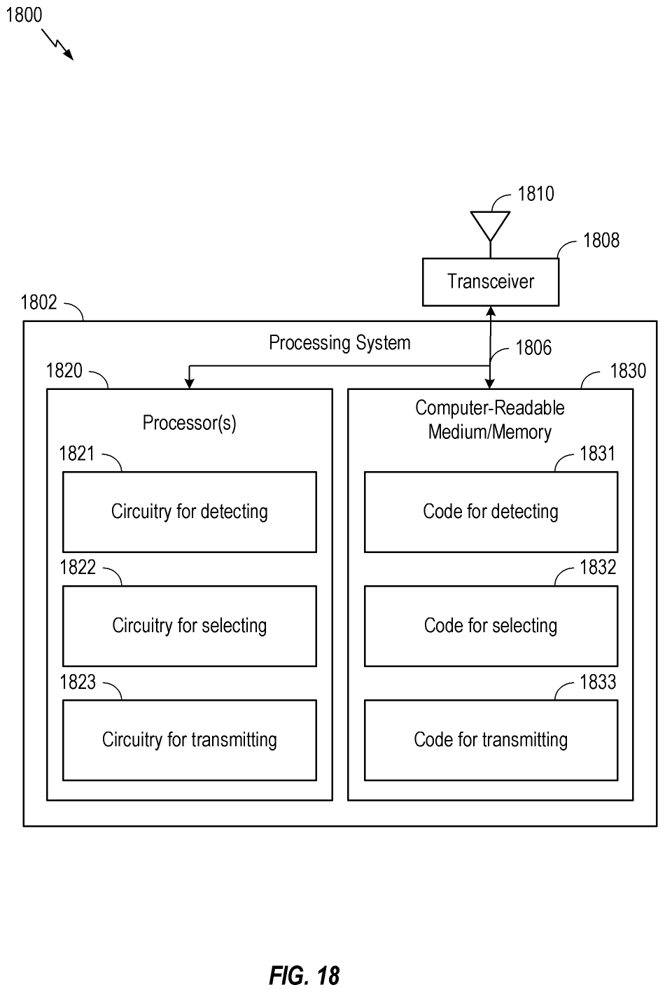

In one aspect, method 1700, or any aspect related to it, may be performed by an apparatus, such as communications device 1800 of FIG. 18, which includes various components operable, configured, or adapted to perform the method 1700. Communications device 1800 is described below in further detail.

Note that FIG. 17 is just one example of a method, and other methods including fewer, additional, or alternative steps are possible consistent with this disclosure.

### Example Communications Devices

FIG. 18 depicts aspects of an example communications device 1800. In some aspects, communications device 1800 is a user equipment, such as UE 104 described above with respect to FIGS. 1 and 3.

The communications device 1800 includes a processing system 1802 coupled to a transceiver 1808 (e.g., a transmitter and/or a receiver). The transceiver 1808 is configured to transmit and receive signals for the communications device 1800 via an antenna 1810, such as the various signals as described herein. The processing system 1802 may be configured to perform processing functions for the communications device 1800, including processing signals received and/or to be transmitted by the communications device 1800.

The processing system 1802 includes one or more processors 1820. In various aspects, the one or more processors 1820 may be representative of one or more of receive processor 358, transmit processor 364, TX MIMO processor 366, and/or controller/processor 380, as described with respect to FIG. 3. The one or more processors 1820 are coupled to a computer-readable medium/memory 1830 via a bus 1806. In certain aspects, the computer-readable medium/memory 1830 is configured to store instructions (e.g., computer-executable code) that when executed by the one or more processors 1820, cause the one or more processors 1820 to perform the method 1700 described with respect to FIG. 17, or any aspect related to it. Note that reference to a processor performing a function of communications device 1800 may include one or more processors performing that function of communications device 1800.

In the depicted example, computer-readable medium/memory 1830 stores code (e.g., executable instructions) for detecting 1831, code for selecting 1832, and code for transmitting 1833. Processing of the code 1831-1833 may cause the communications device 1800 to perform the method 1700 described with respect to FIG. 17, or any aspect related to it.

The one or more processors 1820 include circuitry configured to implement (e.g., execute) the code stored in the computer-readable medium/memory 1830, including circuitry for detecting 1821, circuitry for selecting 1822, and circuitry for transmitting 1823. Processing with circuitry 1821-1823 may cause the communications device 1800 to perform the method 1700 described with respect to FIG. 17, or any aspect related to it.

Various components of the communications device 1800 may provide means for performing the method 1700 described with respect to FIG. 17, or any aspect related to it. For example, means for transmitting, sending or outputting for transmission may include the transceivers 354 and/or antenna(s) 352 of the UE 104 illustrated in FIG. 3 and/or transceiver 1808 and antenna 1810 of the communications device 1800 in FIG. 18. Means for receiving or obtaining may include the transceivers 354 and/or antenna(s) 352 of the UE 104 illustrated in FIG. 3 and/or transceiver 1808 and antenna 1810 of the communications device 1800 in FIG. 18.

### Example Clauses

Implementation examples are described in the following numbered clauses:

Clause 1: A method for wireless communication by a user equipment (UE), comprising: detecting that the UE is scheduled to transmit a first uplink (UL) transmission associated with a first timing advance group (TAG) that at least potentially overlaps with a second uplink transmission associated with a second TAG; selecting, based on one or more conditions, one of the first or second UL transmissions to transmit; and transmitting the selected UL transmission.

Clause 2: The method of Clause 1, wherein the UE detects that the first and second uplink transmissions potentially overlap applying an UL timing advance (TA) for each UL transmission.

Clause 3: The method of Clause 1, wherein the first TAG and the second TAG are different.

Clause 4: The method of Clause 1, wherein transmitting the selected UL transmission comprises: transmitting the selected UL transmission and non-overlapping symbols of the other transmission and dropping overlapping symbols of the other transmission; or transmitting the selected UL transmission and dropping all symbols of the other transmission.

Clause 5: The method of Clause 1, wherein the one or more conditions involve a comparison of a priority index value for the first UL transmission to a priority index value for the second UL transmission.

Clause 6: The method of Clause 1, wherein: the first UL transmission and the second UL transmission comprise sounding reference signals (SRSs); and the one or more conditions involve a comparison of a time domain behavior of the SRS of the first UL transmission to a time domain behavior of the SRS of the second UL transmission.

Clause 7: The method of Clause 5, wherein selecting, based on one or more conditions, one of the first or second UL transmissions to transmit comprises selecting the SRS of the first UL transmission to transmit based at least in part on one of: the time domain behavior of the SRS of the first UL transmission being set as aperiodic and the time domain behavior of the SRS of the second UL transmission being set as semi-persistent or periodic; the time domain behavior of the SRS of the first UL transmission being set as semi-persistent and the time domain behavior of the SRS of the second UL transmission being set as periodic; the time domain behavior of the SRS of the first UL transmission and the second UL transmission being the same and the SRS of the first UL transmission having an earlier starting time than the SRS of the second UL transmission; the time domain behavior of the SRS of the first UL transmission and the second UL transmission being the same and the SRS of the first UL transmission being associated with a lowest or highest TAG ID of the first TAG and second TAG; or the time domain behavior of the SRS of the first UL transmission and the second UL transmission being the same and the SRS of the first UL transmission being associated with a lowest or highest CORESET pool index value, a lowest or highest close loop index value, or a lowest or highest SRS resource set index.

Clause 8: The method of Clause 1, wherein: the first UL transmission comprises a sounding reference signal (SRS) and the second UL transmission comprises a physical uplink control channel (PUCCH); and the one or more conditions involve evaluation of a time domain behavior of the SRS of the first UL transmission and an uplink control information (UCI) type of the PUCCH of the second UL transmission.

Clause 9: The method of Clause 8, wherein selecting, based on one or more conditions, one of the first or second UL transmissions to transmit further comprises: selecting the second UL transmission to transmit based at least in part on: the PUCCH carrying hybrid automatic repeat request (HARQ) acknowledgment information; or the PUCCH carrying channel state information (CSI) and the time domain behavior of the SRS being set as semi-persistent or periodic; or selecting the first UL transmission to transmit based at least in part on the PUCCH not carrying HARQ acknowledgment information and the time domain behavior of the SRS being set as aperiodic.

Clause 10: The method of Clause 1, wherein: the first UL transmission is a sounding reference signal (SRS); and the second UL transmission is a physical uplink shared channel (PUSCH).

Clause 11: The method of Clause 10, wherein selecting, based on one or more conditions, one of the first or second UL transmissions to transmit comprises: selecting the second UL transmission to transmit based at least in part on the priority index associated with the second UL transmission being same as the priority index associated with the first transmission.

Clause 12: The method of Clause 1, wherein: the first UL transmission is a sounding reference signal (SRS) a physical uplink control channel (PUCCH), or a physical uplink shared channel (PUSCH), and the second UL transmission is a physical random access channel (PRACH).

Clause 13: The method of Clause 12, wherein selecting, based on one or more conditions, one of the first or second UL transmissions to transmit comprises: selecting the second UL transmission to transmit.

Clause 14: The method of Clause 12, further comprising determining that the second uplink transmission is associated with the second TAG by: determining that the PRACH is associated with one of a set of TAGs associated with a serving cell where the PRACH is to be transmitted, based on at least one of a control resource set (CORESET) pool index value, a synchronization signal block value (SSB) index, and a default TAG index value; or determining that the PRACH is not associated with any of the TAGs of the serving cell where the PRACH is to be transmitted.

Clause 15: The method of Clause 1, wherein: the first UL transmission comprises a physical uplink control channel (PUCCH) or a physical uplink shared channel (PUSCH) and the second UL transmission comprises a PUCCH or PUSCH; and the one or more conditions involve a comparison of content carried on the first UL transmission to content on the second UL transmission.

Clause 16: The method of Clause 15, wherein selecting, based on one or more conditions, one of the first or second UL transmissions to transmit comprises: selecting the first UL transmission to transmit based at least in part on one of: the first UL transmission carrying hybrid automatic repeat request (HARQ) acknowledgment information or channel state information and the second UL transmission carrying data; the first UL transmission carrying HARQ acknowledgement information and second UL transmission carrying channel state information; the first UL transmission and the second UL transmission carrying same content and the first UL transmission having an earlier starting time than the second UL transmission; the first UL transmission and the second UL transmission carrying the same content and the first UL transmission being associated with a lowest or highest TAG ID; or the first UL transmission and the second UL transmission carrying the same content and the first UL transmission being associated with a lowest or highest control resource set (CORESET) pool index value, a lowest or highest close loop index value, or a lowest or highest resource set index.

Clause 17: The method of Clause 16, wherein the first UL transmission and the second UL transmission are associated with a same priority index.

Clause 18: The method of Clause 1, wherein selecting, based on one or more conditions, one of the first or second UL transmissions to transmit further comprising: select the first UL transmission to transmit based at least in part on a priority index associated with the first UL transmission being larger than a priority index associated with the second UL transmission.

Clause 19: The method of Clause 1, wherein the potential overlap between the first UL transmission and the second UL transmission is larger than a threshold value.

Clause 20: The method of Clause 1, comprising: treating the scheduling as an error case based at least in part on the potential overlap between the first UL transmission and the second UL transmission being less than a threshold value.

Clause 21: An apparatus, comprising: a memory comprising executable instructions; and a processor configured to execute the executable instructions and cause the apparatus to perform a method in accordance with any one of Clauses 1-20.

Clause 22: An apparatus, comprising means for performing a method in accordance with any one of Clauses 1-20.

Clause 23: A non-transitory computer-readable medium comprising executable instructions that, when executed by a processor of an apparatus, cause the apparatus to perform a method in accordance with any one of Clauses 1-20.

Clause 24: A computer program product embodied on a computer-readable storage medium comprising code for performing a method in accordance with any one of Clauses 1-20.

### Additional Considerations

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the general principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various actions may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The various illustrative logical blocks, modules and circuits described in connection with the present disclosure may be implemented or performed with a general purpose processor, a digital signal processor (DSP), an ASIC, a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a system on a chip (SoC), or any other such configuration.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for”. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

1. An apparatus for wireless communication by a user equipment (UE), comprising:
one or more memories comprising executable instructions; and
one or more processors configured to execute the executable instructions and cause the UE to:
detect that the UE is scheduled to transmit a first uplink (UL) transmission associated with a first timing advance group (TAG) that at least potentially overlaps with a second uplink transmission associated with a second TAG;
select, based on one or more conditions, one of the first or second UL transmissions to transmit; and
transmit the selected UL transmission.

2. The apparatus of claim 1, wherein the UE detects that the first and second uplink transmissions potentially overlap applying an UL timing advance (TA) for each UL transmission.

3. The apparatus of claim 1, wherein the first TAG and the second TAG are different.

4. The apparatus of claim 1, wherein transmitting the selected UL transmission comprises:
transmitting the selected UL transmission and non-overlapping symbols of the other transmission and dropping overlapping symbols of the other transmission; or
transmitting the selected UL transmission and dropping all symbols of the other transmission.

5. The apparatus of claim 1, wherein the one or more conditions involve a comparison of a priority index value for the first UL transmission to a priority index value for the second UL transmission.

6. The apparatus of claim 1, wherein:
the first UL transmission and the second UL transmission comprise sounding reference signals (SRSs); and
the one or more conditions involve a comparison of a time domain behavior of the SRS of the first UL transmission to a time domain behavior of the SRS of the second UL transmission.

7. The apparatus of claim 5, wherein selecting, based on one or more conditions, one of the first or second UL transmissions to transmit comprises selecting the SRS of the first UL transmission to transmit based at least in part on one of:
the time domain behavior of the SRS of the first UL transmission being set as aperiodic and the time domain behavior of the SRS of the second UL transmission being set as semi-persistent or periodic;
the time domain behavior of the SRS of the first UL transmission being set as semi-persistent and the time domain behavior of the SRS of the second UL transmission being set as periodic;
the time domain behavior of the SRS of the first UL transmission and the second UL transmission being the same and the SRS of the first UL transmission having an earlier starting time than the SRS of the second UL transmission;
the time domain behavior of the SRS of the first UL transmission and the second UL transmission being the same and the SRS of the first UL transmission being associated with a lowest or highest TAG ID of the first TAG and second TAG; or
the time domain behavior of the SRS of the first UL transmission and the second UL transmission being the same and the SRS of the first UL transmission being associated with a lowest or highest CORESET pool index value, a lowest or highest close loop index value, or a lowest or highest SRS resource set index.

8. The apparatus of claim 1, wherein:
the first UL transmission comprises a sounding reference signal (SRS) and the second UL transmission comprises a physical uplink control channel (PUCCH); and
the one or more conditions involve evaluation of a time domain behavior of the SRS of the first UL transmission and an uplink control information (UCI) type of the PUCCH of the second UL transmission.

9. The apparatus of claim 8, wherein selecting, based on one or more conditions, one of the first or second UL transmissions to transmit further comprises:
selecting the second UL transmission to transmit based at least in part on:
the PUCCH carrying hybrid automatic repeat request (HARQ) acknowledgment information; or
the PUCCH carrying channel state information (CSI) and the time domain behavior of the SRS being set as semi-persistent or periodic; or
selecting the first UL transmission to transmit based at least in part on the PUCCH not carrying HARQ acknowledgment information and the time domain behavior of the SRS being set as aperiodic.

10. The apparatus of claim 1, wherein:
the first UL transmission is a sounding reference signal (SRS); and
the second UL transmission is a physical uplink shared channel (PUSCH).

11. The apparatus of claim 10, wherein selecting, based on one or more conditions, one of the first or second UL transmissions to transmit comprises:
selecting the second UL transmission to transmit based at least in part on the priority index associated with the second UL transmission being same as the priority index associated with the first transmission.

12. The apparatus of claim 1, wherein:
the first UL transmission is a sounding reference signal (SRS) a physical uplink control channel (PUCCH), or a physical uplink shared channel (PUSCH), and
the second UL transmission is a physical random access channel (PRACH).

13. The apparatus of claim 12, wherein selecting, based on one or more conditions, one of the first or second UL transmissions to transmit comprises:
selecting the second UL transmission to transmit.

14. The apparatus of claim 12, wherein the one or more processors are further configured to cause the UE to determine that the second uplink transmission is associated with the second TAG by:
determining that the PRACH is associated with one of a set of TAGs associated with a serving cell where the PRACH is to be transmitted, based on at least one of a control resource set (CORESET) pool index value, a synchronization signal block value (SSB) index, and a default TAG index value; or
determining that the PRACH is not associated with any of the TAGs of the serving cell where the PRACH is to be transmitted.

15. The apparatus of claim 1, wherein:
the first UL transmission comprises a physical uplink control channel (PUCCH) or a physical uplink shared channel (PUSCH) and the second UL transmission comprises a PUCCH or PUSCH; and
the one or more conditions involve a comparison of content carried on the first UL transmission to content on the second UL transmission.

16. The apparatus of claim 15, wherein selecting, based on one or more conditions, one of the first or second UL transmissions to transmit comprises:
selecting the first UL transmission to transmit based at least in part on one of:
the first UL transmission carrying hybrid automatic repeat request (HARQ) acknowledgment information or channel state information and the second UL transmission carrying data;
the first UL transmission carrying HARQ acknowledgement information and second UL transmission carrying channel state information;
the first UL transmission and the second UL transmission carrying same content and the first UL transmission having an earlier starting time than the second UL transmission;
the first UL transmission and the second UL transmission carrying the same content and the first UL transmission being associated with a lowest or highest TAG ID of the first TAG and second TAG;
the first UL transmission and the second UL transmission carrying the same content and the first UL transmission being associated with a lowest or highest control resource set (CORESET) pool index value, a lowest or highest close loop index value, or a lowest or highest resource set index.

17. The apparatus of claim 16, wherein the first UL transmission and the second UL transmission are associated with a same priority index.

18. The apparatus of claim 1, wherein selecting, based on one or more conditions, one of the first or second UL transmissions to transmit further comprising:
select the first UL transmission to transmit based at least in part on a priority index associated with the first UL transmission being larger than a priority index associated with the second UL transmission.

19. The apparatus of claim 1, wherein the potential overlap between the first UL transmission and the second UL transmission is larger than a threshold value.

20. The apparatus of claim 1, wherein the one or more processors are further configured to cause the UE to:
treat the scheduling as an error case based at least in part on the potential overlap between the first UL transmission and the second UL transmission being less than a threshold value.

21-24. (canceled)

25. A method for wireless communication by a user equipment (UE), comprising:
detecting that the UE is scheduled to transmit a first uplink (UL) transmission associated with a first timing advance group (TAG) that at least potentially overlaps with a second uplink transmission associated with a second TAG;
selecting, based on one or more conditions, one of the first or second UL transmissions to transmit; and
transmitting the selected UL transmission.

26. An apparatus for wireless communication by a user equipment (UE), comprising:
means for detecting that the UE is scheduled to transmit a first uplink (UL) transmission associated with a first timing advance group (TAG) that at least potentially overlaps with a second uplink transmission associated with a second TAG;
means for selecting, based on one or more conditions, one of the first or second UL transmissions to transmit; and
means for transmitting the selected UL transmission.
